(19) United States
(12) Patent Application Publication
(10) Pub. No.: US 2025/0105551 A1
(43) Pub. Date: Mar. 27, 2025

(54) ELECTRICAL CONNECTORS WITH HIGH INGRESS PROTECTION

(71) Applicant: IDEAL Industries, Inc., Sycamore, MA (US)

(72) Inventor: Jia Yong Li, Westford, MA (US)

(21) Appl. No.: 18/832,437

(22) PCT Filed: Feb. 16, 2022
(86) PCT No.: PCT/US2022/016591

§ 371 Date: Jul. 23, 2024

Related U.S. Application Data
(60) Provisional application No. 63/304,693, filed on Jan. 30, 2022.

(51) Int. Cl. H01R 13/52

(52) U.S. Cl. CPC H01R 13/5205

(57) ABSTRACT

An electrical connector includes a connector housing comprising an opening, a grommet disposed at least partially within the connector housing and configured to seal an interior of the connector housing from external media, and a clamp disposed about the opening. The grommet includes an inner aperture configured to receive an electrical wire. The clamp includes an outer aperture configured to receive the electrical wire, a passageway extending from the outer aperture to the inner aperture, and at least one rib that forms a boundary of the passageway.

### CROSS-REFERENCE TO RELATED APPLICATION

This application claims the benefit of U.S. Provisional Patent Application No. 63/304,693, filed Jan. 30, 2022, the contents of which are hereby incorporated by reference in its entirety and for all purposes.

### TECHNICAL FIELD

This disclosure generally relates to electrical connectors, including electrical connectors with high ingress protection against dust, water, and other environment.

### BACKGROUND

Electrical connectors may provide protection against ingress of foreign objects, such as dust and water.

### SUMMARY

An example embodiment for an electrical connector includes a connector housing comprising an opening, a grommet disposed at least partially within the connector housing and configured to seal an interior of the connector housing from external media, and a clamp disposed about the opening. The grommet includes an inner aperture configured to receive an electrical wire. The clamp includes an outer aperture configured to receive the electrical wire, a passageway extending from the outer aperture to the inner aperture, and at least one rib that forms a boundary of the passageway.

Another example embodiment for an electrical connector includes a connector housing comprising an opening, a grommet disposed at least partially within the connector housing and configured to seal an interior of the connector housing from external media, and a clamp disposed about the opening. The grommet includes an inner aperture configured to receive an electrical wire, a first grommet portion with a first surface, and a second grommet portion with a second surface. The first surface abuts the connector housing, and the second surface abuts the clamp.

Another example embodiment for an electrical connector includes a connector housing comprising a rear opening, a grommet disposed at least partially within an intermediate portion of the connector housing and configured to seal an interior of the connector housing from external media, a clamp disposed about the rear opening, and an o-ring positioned about a front portion of the connector housing and having an x-shaped cross-sectional profile.

### BRIEF DESCRIPTION OF THE DRAWINGS

FIG. 1 is a front perspective view of an example electrical connector plug.

FIG. 2 is a rear perspective view of the example electrical connector plug.

FIG. 3 is a cross-sectional view of the example electrical connector plug, taken along line 3-3 in FIG. 1.

FIGS. 4A and 4B are rear views of first and second configurations of the example electrical connector plug.

FIG. 5 is a front perspective view of a clamp assembly of the example electrical connector plug.

FIG. 6A is a perspective view of an example grommet of the example electrical connector plug.

FIG. 6B is a side view of the grommet of FIG. 6A.

FIG. 7 is a cross-sectional side view of the example electrical connector plug in connection with an example electrical connector receptacle.

FIG. 8 is a perspective view of an example electrical connector receptacle.

FIG. 9 is a perspective view of an example electrical connector receptacle.

### DETAILED DESCRIPTION

A novel electrical connector according to the present disclosure may provide a high degree of ingress protection through use of a housing and clamp that provide support and structure about a sealing grommet, protecting the grommet from external forces and preventing the grommet from shifting or sliding. The clamp may accommodate different grommet sizes for different wiring sizes, in some embodiments, simplifying the construction and assembly process for the connector. Further, a novel electrical connector according to the present disclosure may include an X-profile o-ring that seals the connection between a plug and receptacle.

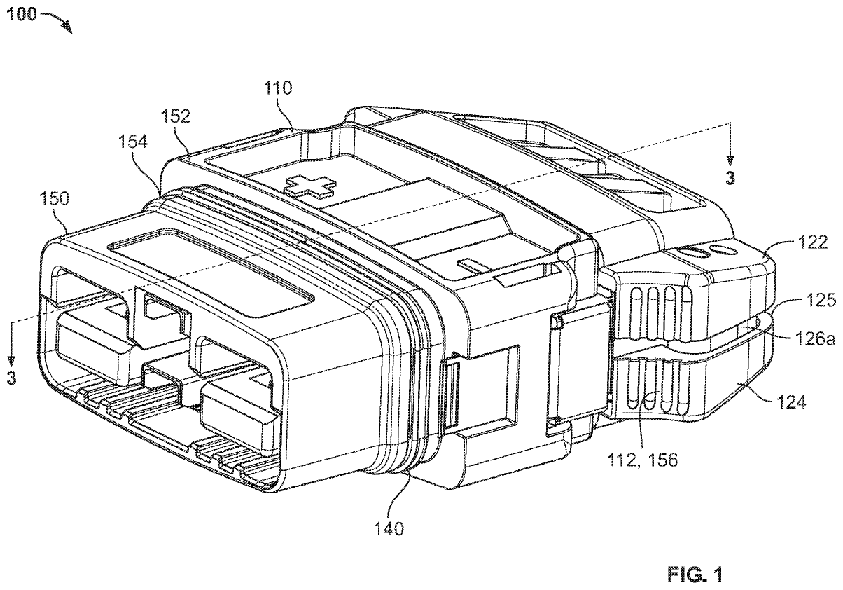

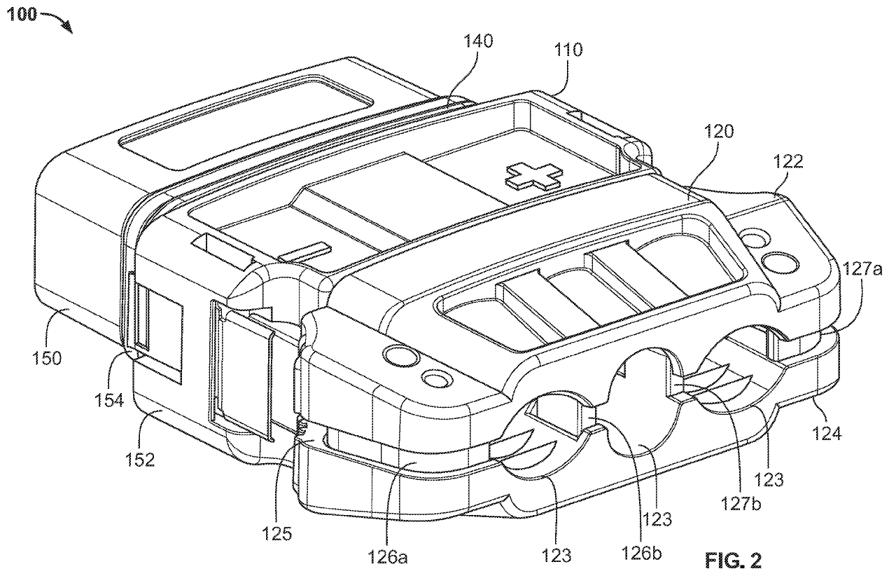

Referring now to the drawings, wherein like numerals refer to the same or similar features in the various views, FIG. 1-3 illustrate an example electrical connector plug 100. The connector plug 100 may include a signal sub-assembly 102, a housing 110, a clamp 120, and a grommet 130. The clamp 120 may be positioned about a rear opening of the housing 110 and include a first clamp portion 122 and a second clamp portion 124, which may collectively form one or more outer apertures 123. Each outer aperture 123 may be continuous with a respective inner aperture 133 defined by the grommet 130, thereby forming a passageway. In operation, a respective electrical wire or cable may extend through each inner aperture 133 to the signal sub-assembly 102 and may be electrically coupled with a respective electrical contact of the signal sub-assembly 102. A jacket of the electrical wire or cable may be substantially the same outer diameter as the diameter of the inner aperture 133, thereby sealing the signal sub-assembly 102 from environmental ingress. The electrical wires or cables connected to the signal sub-assembly 102 may further extend through the outer apertures 123 and beyond the connector for connection to electrical signals sources or destinations.

The clamp 120 may include a grip 112, which may be a textured concave portion configured to receive a user's digit and to ergonomically facilitate use of the electrical connector 100. Accordingly, the user may use the grip 112 to attach the connector 100 to another connector and to detach the connector 100 from another connector. The grip 112 may be provided on a lateral forward-facing edge 156 of the clamp 120. Both the first and second clamp portions 122, 124 may include two respective forward-facing outer edges 156.

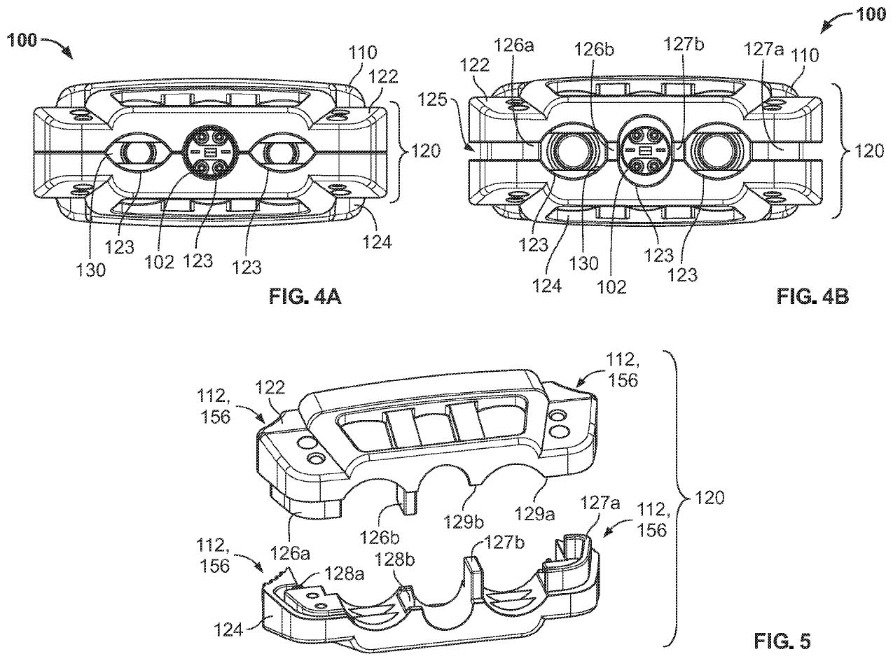

The clamp 120 may include one or more features that enable the same clamp 120 to be used with multiple different wire sizes while still providing strain relief and ingress protection. For example, in a first configuration, such as the configuration shown in FIG. 4A, the first clamp portion 122 and the second clamp portion 124 may be flush or substantially flush with each other (e.g., the parallel planes formed by the flat surfaces of the first clamp portion 122 and the second clamp portion 124 are in contact). In the first configuration, the one or more outer apertures 123 may be relatively small to accommodate relatively small wires. In a second configuration, such as the configuration shown in FIG. 4B, the first clamp portion may be disposed from each other, such that a gap 125 may be formed between the flat surfaces of the first clamp portion 122 and second clamp portion 124. In the second configuration, the one or more outer apertures 123 may be relatively large to accommodate relative large wires. Through such a dynamic range of aperture 123 sizing, the clamp 120 may better relieve strain on the one or more wires due to the more snug fit on the wires within the apertures 123. The first and second configurations of FIGS. 4A and 4B are identical but for different grommet sizes. Specifically, the configuration of FIG. 4A includes a thinner grommet with smaller-diameter apertures, and the configuration of FIG. 4B includes a thicker grommet with larger-diameter apertures.

In order to maintain the structural integrity of the connector plug 100 in general and of the outer apertures 123 in particular in multiple configurations (e.g., for multiple wire and grommet sizes), the clamps may include one or more protective ribs. As shown in FIG. 4B and 5, these protective ribs may include a first outer rib 126a, a first inner rib 126b, a second inner rib 127b, and a second outer rib 127a. The first outer rib 126a and the first inner rib 126b (collectively referred to as “first ribs 126”) may extend outward from a left side of the first clamp portion 122, and the second outer rib 127a and the second inner rib 127b (collectively referred to as “second ribs 127”) may extend outward from a right side of the second clamp portion 124. The second clamp portion 124 may also include a second outer groove 128a and a second inner groove 128b (collectively referred to as “second grooves 128”) that may be configured to receive the first outer rib 126a and the first inner rib 126b respectively. Similarly, the first clamp portion 122 may include a first outer recess 129a and a second outer groove 129b (collectively referred to as “first grooves 129”) that may be configured to receive the second outer rib 127a and the second inner rib 127b respectively.

When the second clamp portion 124 is mated with the first clamp portion 122, the second ribs 127 of the second clamp portion 124 may be configured to fit within the first grooves 129 of the first clamp portion 122, while the second grooves 128 of the second clamp portion 124 may be configured to receive the first ribs 126 of the first clamp portion 122. As such, when the first clamp portion 122 and second clamp portion 124 are mated but not flush (e.g., the second configuration of FIG. 4B), the protective ribs may extend longitudinally between the clamp portions and be partially exposed to define the lateral boundaries of the outer apertures 123, providing structure to the combination and protection between the outer apertures 123. The protective ribs, therefore, may allow the connector plug 100 to accommodate larger wire sizes while maintaining high levels of insulation from external media and without sacrificing structural integrity.

In some embodiments, the first clamp portion 122 and the second clamp portion 124 may be identical (or substantially identical components), such that the second clamp portion 124 may be the first clamp portion 122 flipped by 180 degrees. Similarly, the first ribs 126 and the second ribs 127 may be substantially identical, and the first grooves 129 and the second grooves 128 may be substantially identical.

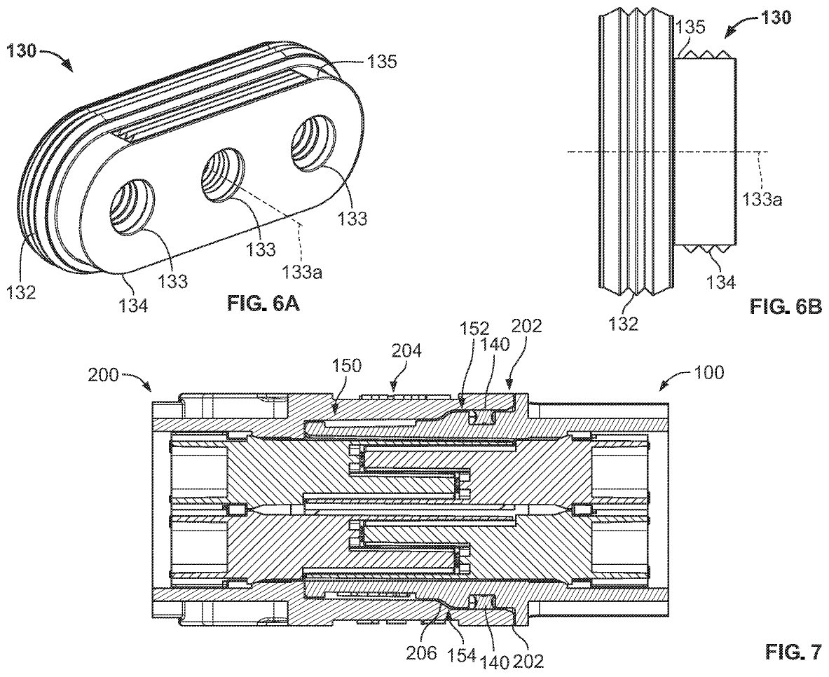

FIGS. 6A and 6B illustrate an example grommet 130 in greater detail. The grommet 130 may receive one or more wires through the inner apertures 133 and seal the connection of those wires to an internal signal sub-assembly 102 in an interior of the housing 110 from external media. The grommet 130 may be made of a pliable material that is capable of compression without compromising its structural integrity (e.g., silicon rubber).

The grommet 130 may include a first grommet portion 132, a second grommet portion 134, and one or more inner apertures 133 that may be continuous with the one or more outer apertures 123 of the clamp 120. The second grommet portion 134 may be positioned between the first grommet portion 132 and the rear opening of the housing 110 about which the clamp 120 may be positioned. In some embodiments, such as the one shown in FIG. 6A, the first grommet portion 132 may be larger than the second grommet portion 134 (e.g., a perimeter of an external surface of the first grommet portion 132 is greater than a perimeter of an external surface of the second grommet portion 134), such that the grommet 130 includes a step-bevel 135. The external surfaces of each of the first grommet portion 132 and the second grommet portion 134 are parallel to an axis 133a that is defined by a center of the inner aperture 133.

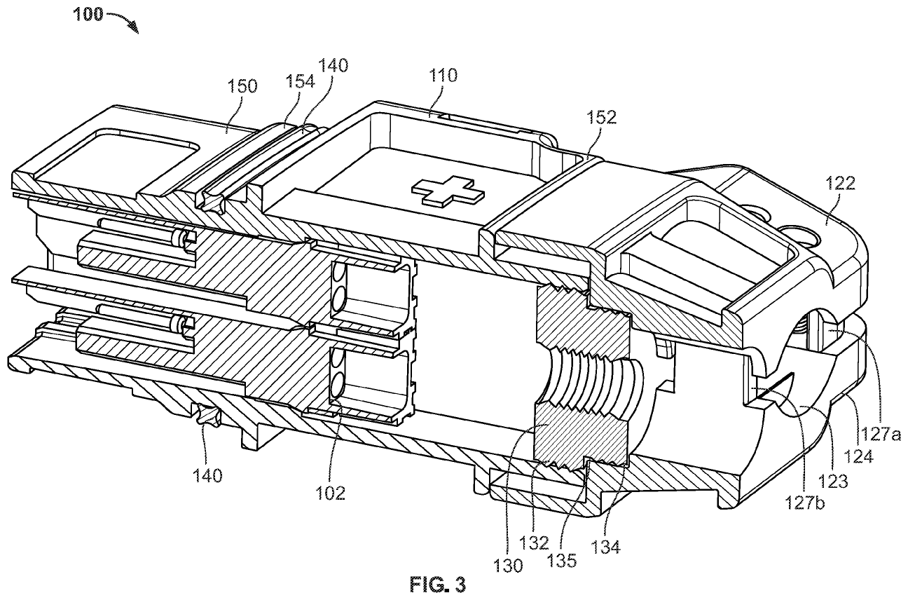

Referring to FIG. 3, the step-bevel 135 of the grommet 130 may enable the grommet to have a snug fit with both the housing 110 and the clamp 120. In particular, the first grommet portion 132 may abut the housing 110 and the second grommet portion 134 may abut the clamp 120, such that the grommet 130 receives pressure from both the housing 110 and the clamp 120.

The grommet 130 being in contact with each of the housing 110 and the clamp 120 provides at least three primary benefits. First, the overall surface area of the grommet 130 that is in contact with some outer structural portion of the plug connector 100 is increased, which increases the frictional resistance that prevents movement of the grommet 130 within the connector plug 100. To this end, each of the first grommet portion 132 and the second grommet portion 134 may further include a textured external surface (e.g., ribs, ridges, etc.) that are configured to further the amount of surface area of the grommet 130 that is in contact with the housing 110 and clamp 120, which increases a correlated amount of friction. Second, the step-bevel enables the grommet 130 to make surface contact with the clamp 120 on a plane perpendicular to the apertures 133. This perpendicular contact may provide a stop for the grommet 130, which supplements the frictional resistance to further prevent movement of the grommet 130 within the connector plug. Third, the first grommet portion 132 provides structural support for the housing 110, as the space between the grommet 130 and the signal sub-assembly 102 may be empty and lacking support. Because the grommet 130 directly contacts the housing 110, the grommet 130 may prevent compression forces on the housing 110 from causing the housing 110 to buckle or otherwise warp.

In addition to features that provide sealing and support at the rear of the connector 100, as described above, the connector 100 may include additional features that provide sealing at the front of the connector 100. For example, referring now to FIG. 7, the connector plug 100 is shown as coupled with a connector receptacle 200. An “x” profile (or x-shaped) o-ring 140 positioned about the connector plug 100 may seal the internal connection between the connectors 100, 200 from external debris (e.g., water, dust, etc.). The ‘x’ refers to the cross-sectional shape of the o-ring 140, taken across the width of the o-ring 140. This cross-sectional shape may provide benefits over existing o-rings (e.g., with circular cross-sections) used in electrical connectors. First, the ‘x’ shape has four total points of contact with the surrounding surfaces (e.g., two points of contact on the connector plug 100 and two points of contact on connector receptacle 200), which creates a better seal than existing circular shape o-rings that may have only a single point of contact with each surface. Second, due in part to the additional points of contact, the ‘x’ shape o-ring 140 may form a seal with less compression applied, which reduces strain on the o-ring 140 and increases its usable life. The ‘x’ shape o-ring 140 may be made of an elastomer.

The connector housing 110 may include a forward portion 150 having a relatively smaller outer width and an intermediate portion 152 having a relatively larger outer width. An angled transition portion wall 154 may be disposed between the forward portion 150 and the intermediate portion 152. The o-ring 140 may be disposed about the intermediate portion 152, rearward of the transition portion wall 154.

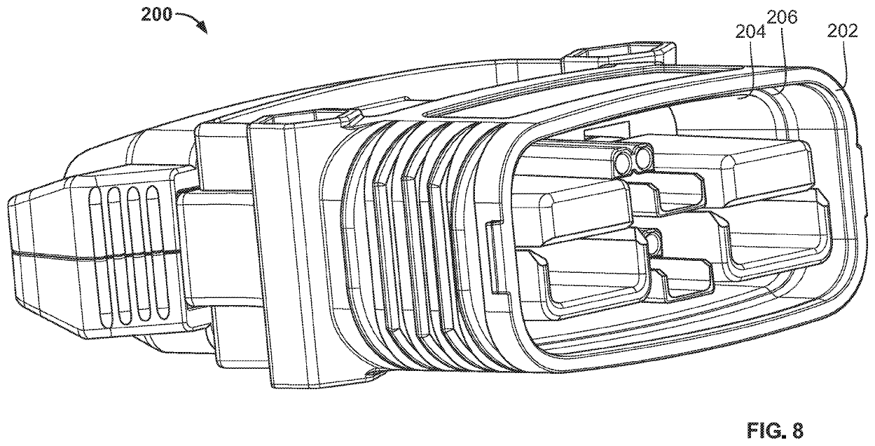

Referring to FIG. 8, a perspective view of the example electrical connector receptacle 200 is shown. The receptacle 200 includes an outer portion 202 having a relatively larger inner width, an inner portion 204 having a relatively smaller width, and an angled intermediate portion wall 206 between the outer portion 202 and the inner portion 204. The connector receptacle 200 may be configured to mate with the connector plug 100 (e.g., as shown in FIG. 7) by fitting the outer portion 202 around the forward portion 150 of the connector plug 100. When mated, the o-ring 140 contacts the inner surface of the outer portion 202, forming a seal as discussed above. Because the outer portion 202 may have a larger inner width larger than the inner portion 204, the o-ring 140 may not interact with the connector receptacle 200 until the connector plug 100 is substantially inserted, preventing unnecessary wear on the o-ring 140 and improving the smoothness of the insertion process.

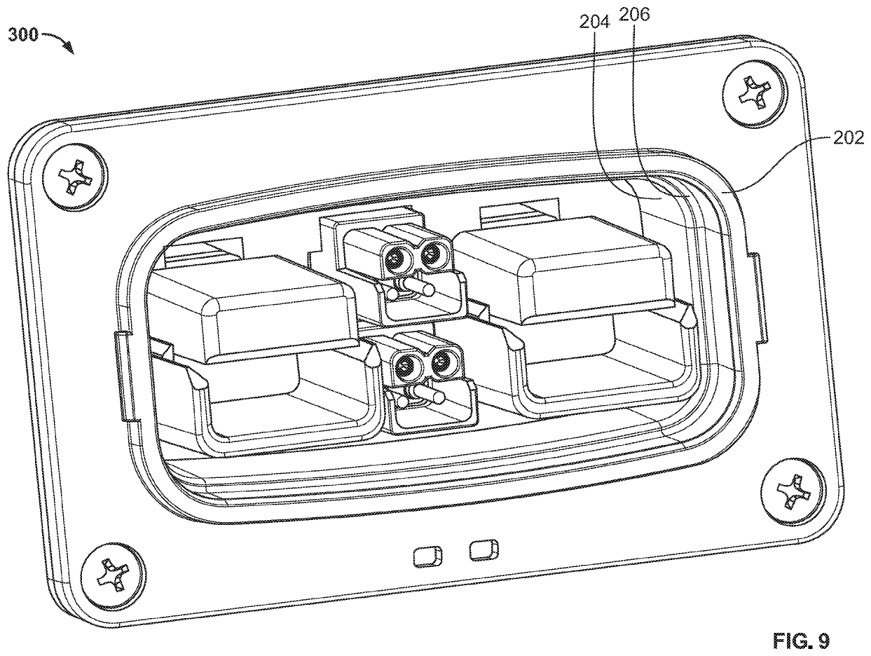

FIG. 9 shows an example electrical connector wall receptacle 300 that is similarly configured to mate with the connector plug 100 and includes an outer lip 302 and an inner lip. Although not shown, both the connector receptacle 200 and wall receptacle 300 have rear construction that may be identical to the construction of the rear portion of the connector plug 100 illustrated and described herein.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

What is claimed is:

1. An electrical connector comprising:
a connector housing comprising an opening;
a grommet disposed at least partially within the connector housing and configured to seal an interior of the connector housing from external media, the grommet comprising an inner aperture configured to receive an electrical wire; and
a clamp disposed about the opening, the clamp comprising:
an outer aperture configured to receive the electrical wire;
a passageway extending from the outer aperture to the inner aperture; and
at least one rib that forms a boundary of the passageway.

2. The electrical connector of claim 1, wherein the clamp further comprises a first clamp portion and a second clamp portion, the at least one rib comprises a first rib and a second rib, and wherein:
the first clamp portion comprises the first rib and a first groove,
the second clamp portion comprises the second rib and a second groove,
the first rib is configured to fit within the second groove, and
the second rib is configured to fit within the first groove.

3. The electrical connector of claim 2, wherein:
in a first configuration, the first rib is substantially contained within the second groove and the second rib is substantially contained within the first groove; and
in a second configuration, the first rib is partially contained with the second groove and partially exposed, and the second rib is partially contained within the first groove and partially exposed.

4. The electrical connector of claim 2, wherein the first clamp portion is substantially identical to the second clamp portion.

5. The electrical connector of claim 1, wherein:
the grommet comprises a first grommet portion with a first surface and a second grommet portion with a second surface,
the first surface abuts the connector housing, and
the second surface abuts the clamp.

6. The electrical connector of claim 1, wherein the passageway defines a longitudinal direction and the at least one rib extends longitudinally to define a lateral boundary of the passageway.

7. The electrical connector of claim 1, further comprising an o-ring positioned about the connector housing and having an x-shaped cross-sectional profile.

8. The electrical connector of claim 1, wherein the connector housing further comprises a concave textured portion configured to provide an ergonomic grip on the connector housing.

9. An electrical connector comprising:
a connector housing comprising an opening;
a grommet disposed at least partially within the connector housing and configured to seal an interior of the connector housing from external media, the grommet comprising:
an inner aperture configured to receive an electrical wire;
a first grommet portion with a first surface; and
a second grommet portion with a second surface; and
a clamp disposed about the opening,
wherein the first surface abuts the connector housing, and the second surface abuts the clamp.

10. The electrical connector of claim 9, wherein the clamp further comprises:
an outer aperture configured to receive the electrical wire;
a passageway extending from the outer aperture to the inner aperture; and
at least one rib that forms a boundary of the passageway.

11. The electrical connector of claim 9, wherein the first surface and second surface are substantially parallel to an axis defined by a center of the inner aperture.

12. The electrical connector of claim 9, wherein the second grommet portion is positioned between the first grommet portion and the opening.

13. The electrical connector of claim 9, wherein:
the electrical connector comprises a first configuration and a second configuration,
the second grommet portion is thicker in the second configuration than in the first configuration, and
a diameter of the inner aperture is larger in the second configuration than in the first configuration.

14. The electrical connector of claim 9, further comprising an o-ring positioned about the connector housing and having an x-shaped cross-sectional profile.

15. The electrical connector of claim 9, wherein the connector housing further comprises a concave textured portion configured to provide an ergonomic grip on the connector housing.

16. An electrical connector comprising:
a connector housing comprising a rear opening;
a grommet disposed at least partially within an intermediate portion of the connector housing and configured to seal an interior of the connector housing from external media;
a clamp disposed about the rear opening; and
an o-ring positioned about a front portion of the connector housing and having an x-shaped cross-sectional profile.

17. The electrical connector of claim 16, wherein:
the grommet further comprises:
an inner aperture configured to receive an electrical wire;
a first grommet portion with a first surface abutting the intermediate portion of the connector housing; and
a second grommet portion with a second surface abutting the clamp; and
the clamp further comprises:
an outer aperture configured to receive the electrical wire;
a passageway extending from the outer aperture to the inner aperture; and
at least one rib that forms a boundary of the passageway.

18. The electrical connector of claim 16, wherein an outer width of the front portion is relatively smaller than an outer width of the intermediate portion, and wherein the front portion is configured to be received by a connector receptacle.

19. The electrical connector of claim 18, wherein the o-ring contacts the front portion at at least two points and the connector receptacle at at least two points.

20. The electrical connector of claim 16, wherein the connector housing further comprises a concave textured portion configured to provide an ergonomic grip on the connector housing.
